(19) United States
(12) Patent Application Publication
(10) Pub. No.: US 2026/0061899 A1
(43) Pub. Date: Mar. 5, 2026

(54) CHILD RESTRAINT

(71) Applicant: Maxi Milaan B.V., Helmond (NL)

(72) Inventors: Dennis OLFERS, Leende (NL); Sander Gerardus Toonders, Valkenswaard (NL)

(21) Appl. No.: 19/311,612

(22) Filed: Aug. 27, 2025

(30) Foreign Application Priority Data
Aug. 28, 2024 (EP) 24197003.7

(51) Int. Cl. B60N 2/28

(52) U.S. Cl. CPC B60N 2/2816; B60N 2/2806; B60N 2/2851

(57) ABSTRACT

A child restraint includes seat shell including a seat bottom, a backrest coupled to the seat bottom, and a headrest. The headrest is mounted to the backrest for upward and downward movement relative to the backrest between a lowered position spaced a first distance from the seat bottom and a raised position spaced a second distance greater than the first distance. The headrest includes a headrest shell configured to support a head of a child and a belt guide coupled to the headrest shell and formed to include a belt path. The belt path is configured to receive a vehicle seat belt when the headrest is in the raised position to establish a booster seat mode of the child restraint.

### PRIORITY CLAIM

This application claims priority under 35 U.S. C. § 119(a) to European Patent Application No. EP24197003.7, filed Aug. 28, 2024, which is expressly incorporated by reference herein in its entirety.

### BACKGROUND

The present disclosure relates to a child safety device, and particularly to a child restraint. More particularly, the present disclosure relates to a child restraint for use in a vehicle.

### SUMMARY

According to the present disclosure, a child restraint includes a seat shell including a seat bottom, a backrest coupled to the seat bottom, and a headrest. The headrest is mounted to the backrest for upward and downward movement relative to the backrest between a lowered position spaced a first distance from the seat bottom and a raised position spaced a second distance greater than the first distance.

In illustrative embodiments, the headrest includes a headrest shell configured to support a head of a child and a belt guide coupled to the headrest shell and formed to include a belt path. The belt path is configured to receive a vehicle seat belt when the headrest is in the raised position to establish a booster seat mode of the child restraint.

In illustrative embodiments, the headrest further includes a belt-installation controller coupled to the belt guide. The belt-installation controller is moveable relative to the belt guide between an interference configuration and an installation configuration. When the headrest is in the lowered position, the belt-installation controller establishes the interference configuration and blocks installation of the vehicle seat belt with the belt guide. When the headrest is in the raised position, the belt-installation controller establishes the installation configuration and the belt guide is free to receive the vehicle seat belt to establish the booster seat mode.

Additional features of the present disclosure will become apparent to those skilled in the art upon consideration of illustrative embodiments exemplifying the best mode of carrying out the disclosure as presently perceived.

### BRIEF DESCRIPTIONS OF THE DRAWINGS

The detailed description particularly refers to the accompanying FIGS. in which:

FIG. 1 is a perspective view of a child vehicle seat with a headrest in a first position,

FIG. 2 is a perspective view of the child vehicle seat as shown in FIG. 1, with the headrest in second position,

FIG. 3 is a schematic front view of a part of child vehicle seat according to the present disclosure,

FIG. 4A is a schematic front view of a first embodiment of the present disclosure in the first position of the abutment element and the first operating position of the operating element,

FIG. 4B is a detailed front view of the first embodiment of the present disclosure in the first position of the abutment element and the first operating position of the operating element,

FIG. 4C is a cross section of the first embodiment of the present disclosure in the first position of the abutment element and the first operating position of the operating element,

FIG. 5A is a detailed front view of the first embodiment of the present disclosure in the transition position of the abutment element,

FIG. 5B is a cross section of the first embodiment of the present disclosure in the transition position of the abutment element,

FIG. 6A is a schematic front view of the first embodiment of the present disclosure in the second position of the abutment element and the second operating position of the operating element,

FIG. 6B is a detailed front view of the first embodiment of the present disclosure in the second position of the abutment element and the second operating position of the operating element,

FIG. 6C is a cross section of the first embodiment of the present disclosure in the second position of the abutment element and the second operating position of the operating element,

FIG. 7 is cross sections of a second embodiment of the present disclosure in the transition position of the abutment element,

FIG. 8 is a cross section of a third embodiment of the present disclosure in the transition position of the abutment element, and

FIG. 9 is a cross section of a fourth embodiment of the present disclosure in the transition position of the abutment element.

### DETAILED DESCRIPTION

A child restraint 1 includes a shell configured to support at least a portion of a child for transportation in a vehicle. The shell includes a base 2, a seat 3, and a headrest 8. The base 2 is adapted to be placed on a vehicle seat to support the seat 3 thereon. The seat 3 is configured to hold and support a child. The headrest 8 is movable relative to the seat 3 to change an elevation of the headrest 8 from the base 2.

In illustrative embodiments, the headrest 8 is repositionable along a backrest 7 of the seat 3 to establish in a first seating mode for children of a first size and a second seating mode for children of a second size. The first seating mode can support a smaller child with the headrest 8 located a first distance from a seat portion 6 of the seat 3. The second seating mode can support a larger child with the headrest 8 located a second distance greater than the first distance from the seat portion 6 of the seat 3.

In illustrative embodiments, the headrest 8 includes a headrest shell or body 50 configured to support a head of a child, a belt guide 19 coupled to the headrest shell 50, and a belt-installation controller 52. The belt guide 19 is formed to include a belt path configured to receive a vehicle seat belt when the headrest 8 is in the raised position to establish a booster seat mode of the child restraint 1. The belt-installation controller 52 is coupled to the belt guide 19 and moveable relative to the belt guide 19 between an interference configuration and an installation configuration.

When the headrest 8 is in a lowered position, the belt-installation controller 52 assumes the interference configuration and blocks installation of the vehicle seat belt with the belt guide 19. When the headrest 8 is in a raised position, the belt-installation controller 52 assumes the installation configuration and the belt guide 19 is free to receive the vehicle seat belt to establish the booster seat mode.

The belt-installation controller 52 includes a belt path shield 41 coupled to the belt guide 19 and a shield actuator 54. The belt-path shield 41 is configured to cover an inlet to the belt path 19 in the interference position to block entry of the attachment belt. The shield actuator 54 is coupled to the belt path shield 41 and is configured to move the belt path shield 41 relative to the belt guide 19 in response to the headrest 8 changing from the lower position (i.e. a first seating mode) to the raised position (i.e. a second seating mode).

The shield actuator 54 includes an abutment member 35 configured to engage a portion of the seat shell, a connector 45, a first basing member 38, and a second biasing member 44. The connector 45 is coupled to the abutment member 35 and to the belt path shield 41. The first biasing member 38 is coupled to the abutment member 35 and is configured to urge the abutment member 35 toward the portion of the seat shell.

The second biasing member 44 is coupled to the belt path shield 41 and is configured to urge the belt path shield 41 to cover the inlet to the belt path 19 to establish the interference position when the headrest 8 is in the lowered position. The first biasing member 38 is configured to move the abutment member 35, the connector 45, and the belt-path shield 41 to establish the installation configuration when the headrest 8 is in the raised position.

In illustrative embodiments, the portion of the seat shell engaged with the abutment member 35 is a portion of the backrest 7. The portion of the seat shell includes a first step 32, a second step 33, and a transition surface 34 between the first step 32 and the second step 33. The abutment member 35 engages the first step 32 when the seat shell is in the first seating mode to establish the interference configuration. The abutment member 35 interfaces with the second step 33 when the seat shell is in the second seating mode to cause the first biasing member 38 to pull the connector 45 and the belt path shield 41 to the installation position so that the belt path 19 is open to receive the vehicle seat belt or another suitable attachment belt.

The first step 32 is spaced a first distance from the headrest 8 and the second step 33 is spaced a second distance from the headrest greater than the first distance. This provides space for the abutment member 35 to extend into once the abutment member 35 clears the transition surface 34 as the headrest 8 is raised.

While the belt path 19 is shown as being a part of the headrest 8 in the illustrative embodiment, is should be appreciated that the belt path 19 can be located in other areas of the child restraint, such as in the backrest 7, the seating portion 6, or the seat base 2. Child restraints can have belt paths in a variety of areas, and the belt-installation controller 52 can be used in any such belt paths.

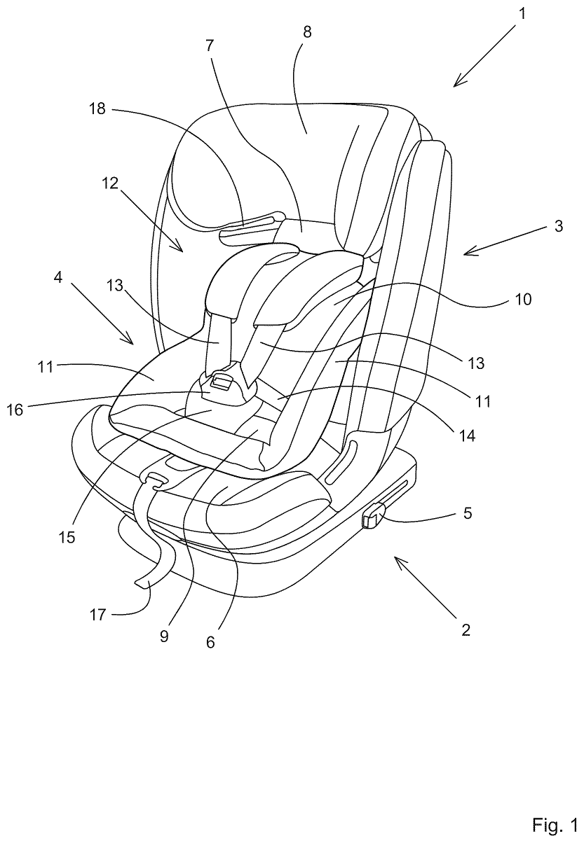

FIGS. 1 and 2 show perspective views of a child vehicle seat 1. The child vehicle seat 1 comprises a base 2, a seat 3 and a removable inlay 4 for reducing the size of the seat 3.

The base 2 can be provided on both sides with ISOFIX-connectors being slidable in and out the base 2 by means of knobs 5. By means of the ISOFIX-connectors the child vehicle seat 1 can be connected in a manner known per se to a vehicle.

The seat 3 is provided with a seat portion 6, a backrest portion 7 and a movable headrest 8.

The inlay 4 is provided with an inlay seat portion 9, an inlay backrest portion 10 and side portions 11 extending between the inlay seat portion 9 and inlay backrest portion 10. As can be seen in FIG. 1, the inlay seat portion 9 rests on the seat portion 6 whilst the inlay backrest portion 10 rests against the backrest portion 7 of the seat 3. Due to the side portions 11 of the inlay 4 the width of the seat is reduced. When using the inlay 4, a harness 12 is connected to the seat 3 and the inlay 4, which harness 12 comprises two shoulder belts 13, two side belts 14 and one crotch belt 15 being detachably connected to each other by means of a buckle 16. The belts of the harness 12 can be tensioned by means of strap 17.

In FIG. 1 the headrest 8 is in a first headrest position and will be used as a group 0/1 seat for small children.

In FIG. 2 the headrest 8 is being moved in the direction as indicated by arrow P1 to a second headrest position. Furthermore, no inlay portion 4 as shown in FIG. 1 is present so that the child vehicle seat can be used as a group 2/3 seat for larger children.

As can be seen in the FIGS. 1 and 2, the headrest 8 is provided with belt guides 18 for guiding a shoulder portion of the vehicle belt (not shown). In some child seats, the belt guides 18 are always accessible, also when the child vehicle seat 1 is being used as a group 0/1 seat for small children. This has the risk that a user, like a parent or other adult, accidentally uses the vehicle belt instead of or in addition to the harness 12. This is undesirable and risky for the child.

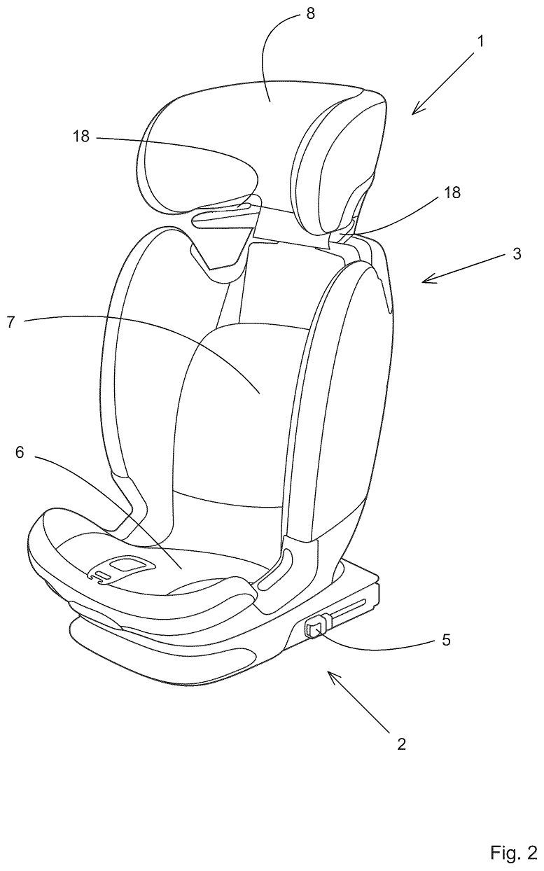

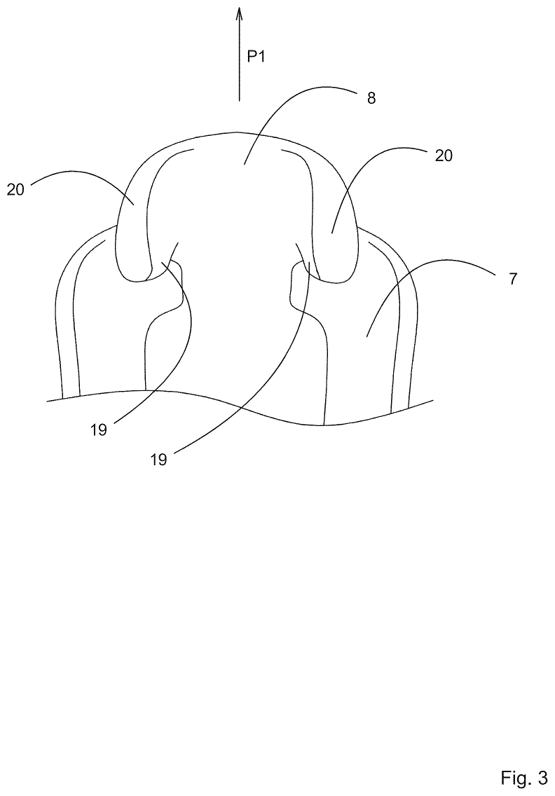

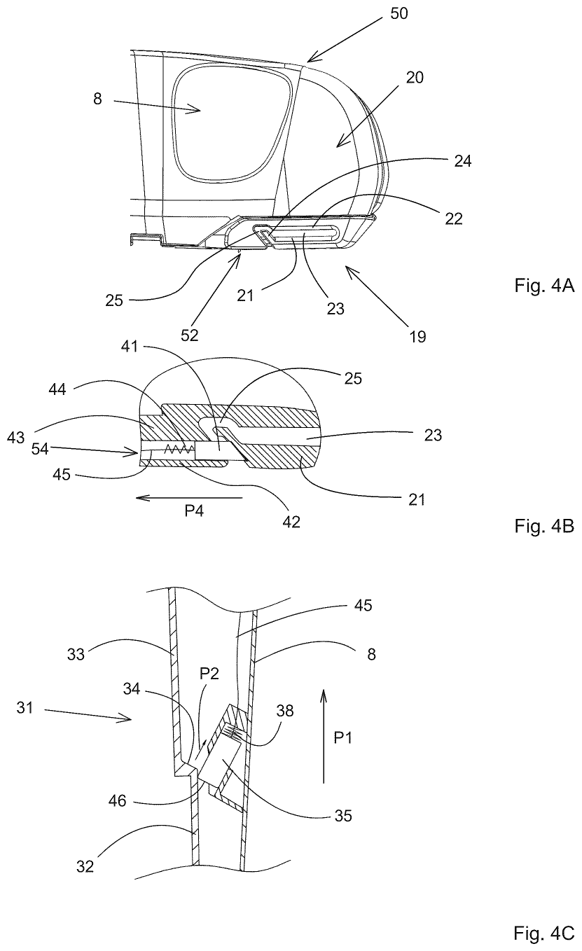

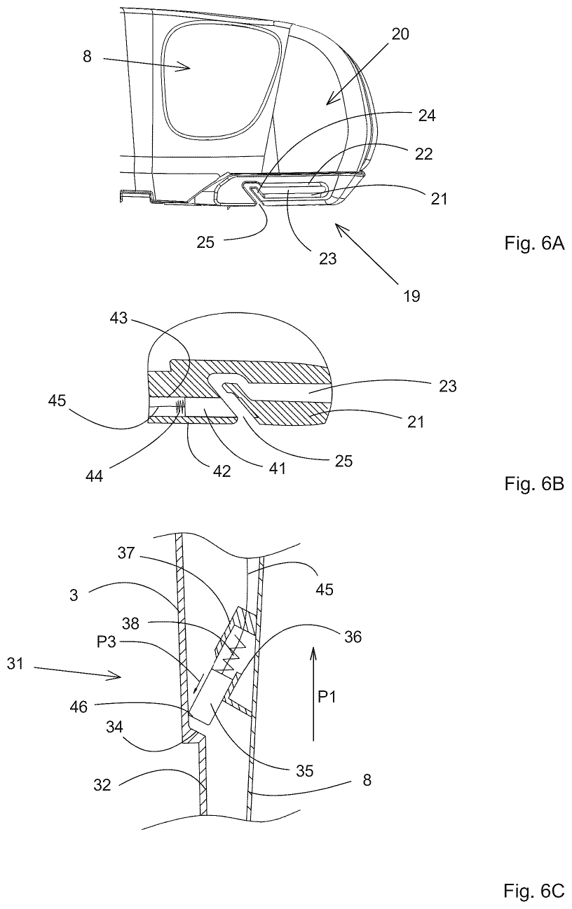

FIG. 3 is a schematic front view of a part of child vehicle seat 1 according to the present disclosure, showing a backrest portion 7 and a headrest 8 being movable in and opposite to the direction as indicated by arrow P1 from a first headrest position as shown in FIG. 3 to a second headrest position as shown in FIG. 2. The headrest 8 is located closer to the seat portion 6 in the first headrest position than in the second headrest position. The headrest 8 comprises two belt guides 19, one on each lateral side support 20 of the headrest 8. In FIG. 3 only the position of the belt guides 19 is indicated. In FIGS. 4A and 6A, the belt guides 19 are shown in full detail.

Each belt guide 19 comprises two parts 21, 22 extending parallel at a distance of each other, thereby defining a space 23 to accommodate the vehicle belt. The part 21 is provided with a part 24 directed upwards and towards a centreline of the headrest 8. Around part 24 is a U-shaped opening 25 to be used for inserting the vehicle belt into the space 23 and blocking the vehicle belt to easily slide out of the space 23.

FIGS. 4A-6C are a schematic front view, a detailed front view and a cross section of a first embodiment of the present disclosure in the different positions.

The child vehicle seat 1 according to the present disclosure is similar to the child vehicle seat 1 as shown in the FIGS. 1 and 2, except that the belt guides 19 differs from the belt guides 18. Furthermore, the child vehicle seat 1 according to the present disclosure comprises two step shaped elements 31 each provided with a first higher step 32, a second lower step 33 as well as a transition surface 34 located between the first higher step 32 and the second lower step 33. The step shaped elements 31 extend substantially vertically and are provided on the backrest portion 7 below and behind the belt guides 19. The transition surface 34 is inclined. The first higher step 32 is located closer to the seat portion 6 and the headrest 8 than the second lower step 33.

The child vehicle seat 1 according to the present disclosure also comprises two abutment elements 35 each located opposite the nearest step shaped element 31. It is also possible to use a single abutment element 35 and a single step shaped element 31.

The abutment element 35 is slidably located between two support parts 36, 37 being connected to the headrest 8. The abutment element 35 extends towards the seat portion 6. The abutment element 35 is slidable in directions as indicated by arrow P2, P3 against respectively under spring force of spring 38.

The child vehicle seat 1 according to the present disclosure also comprises two operating elements 41. Each operating element 41 is slidably located between two support parts 42, 43 being located opposite part 21 of the belt guide 13 and near opening 25. Each operating element 41 is slidable in and opposite to the direction as indicated by arrow P4 against and under spring force of spring 44.

Each operating element 41 is connected to the corresponding or single abutment element 35 by means of a connector. The connector comprises a cable 45 connected with a first end to the abutment element 35 and with a second end to the operating element 41.

The operation of the child vehicle seat 1 according to the present disclosure is as follows.

In the first position as shown in the FIGS. 4A-4C, the headrest 8 is relatively close to the seat portion 6 and the abutment element 35 is under spring force of spring 38 in abutment with the first higher step 32. The first spring 38 is compressed. The spring force of the first spring 38 is larger than the spring force of the second spring 44. The second spring 44 is extended. The cable 45 has such a length that the operating element 41 has been moved under spring force of spring 44 against part 21 of the belt guide 19, thereby closing the opening 25. Since the opening 25 is closed a user cannot insert a shoulder portion of the vehicle belt into the belt guide 19.

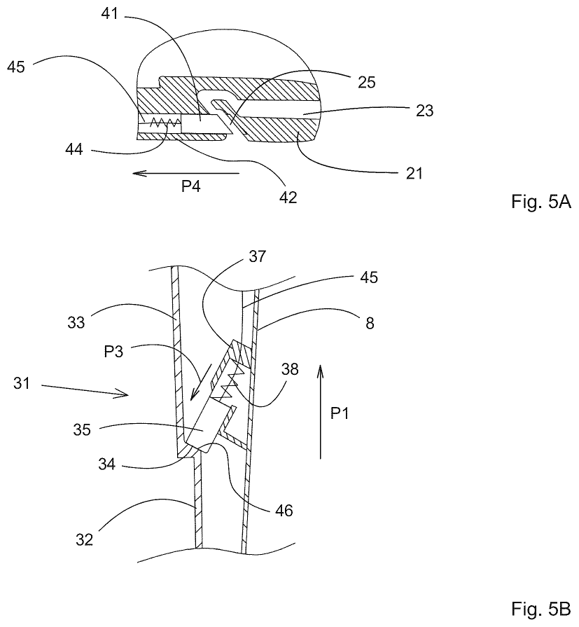

When the user pulls the headrest 8 upwards in the direction as indicated by arrow P1, an end 46 of the abutment element 35 slides along the first higher step 32 until the abutment element 35 reaches the transition surface 34. The end 46 of the abutment element 35 will then slide over the transition surface 34 into a transition position, whereby under the spring force of spring 38 the abutment element 35 will gradually slide in the direction as indicated by arrow P3. The abutment element 35 will pull on the cable 45, thereby pulling the operating element 41 has been moved under spring force of spring 44 in the direction as indicated by arrow P3, thereby gradually open the opening 25. See FIGS. 5A-5B.

The headrest 8 can be positioned in a number of different headrest positions. The transition position is preferably located between a first set of different headrest positions and a second set of different headrest positions so that in a headrest position, the abutment element 35 always be in abutment with the first higher step 32 or the second lower step 34 so that the opening 25 is either fully closed or fully opened.

When the user pulls the headrest 8 further upwards in the direction as indicated by arrow P1, the end 46 of the abutment element 35 will slide along the second lower step 34, whereby the abutment element 35 is being moved to the second position. See FIGS. 6A-6C. In the second position, the operating element 41 has been pulled against spring force of spring 44 completely between the parts 43, 43 into the second operating position so that the opening 25 is completely opened. In the second position of the abutment element 35, the headrest 8 is in the second headrest position so that the child vehicle seat can be used as a group 2/3 seat for larger children. In the second position of the abutment element 35, the first spring 38 is extended, whilst the second spring 44 is compressed. The child will be maintained in the child vehicle seat 1 by means of the vehicle belt, with the shoulder portion of the vehicle belt extending through the belt guide 19.

When the headrest 8 is being moved from the second headrest position (FIGS. 6A-6C) towards the first headrest position (FIGS. 4A-4C), the end 46 of the abutment element 35 will slide along the second lower step 34, and subsequently over the transition surface 34 and the first higher step 34, whereby the abutment element 35 will be pushed against spring force of the spring 38 towards the headrest 8. By doing so the end of the cable 45 connected to the abutment element 35 will also be moved towards the headrest 8 and will allow the end of the cable 45 connected to the operating element 41 as well as the operating element 41 to be moved under spring force of spring 44 in an opposite direction as indicated by arrow P4 towards part 21 into the first operating position, thereby closing the opening 25.

In the first embodiment as shown in the FIGS. 4A-6C, the abutment element 35 comprises a pen.

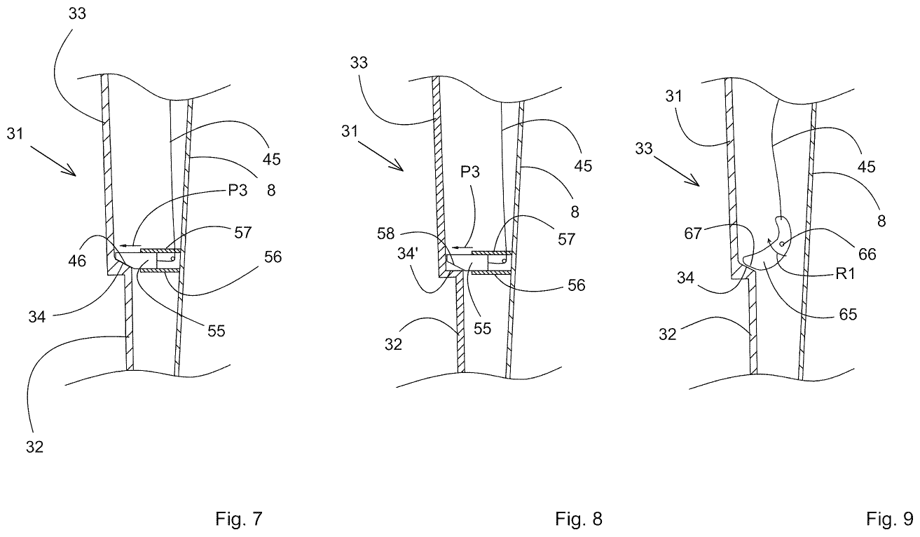

FIGS. 7-9 show cross sections of a second, third and fourth embodiment of the present disclosure in the transition position of the abutment element. Only different embodiments of the step shaped element and abutment element are shown. The operating elements remain the same.

In FIG. 7, the abutment element 55 is slidably located between two support parts 56, 57 being connected to the headrest 8 and extends substantially horizontal towards the step shaped element 31. Between the headrest 8 and the abutment element 55 a spring (not shown) is located pushing the abutment element 55 towards to and in abutment with the step shaped element 31. The abutment element 55 is provided near an end with an inclined surface 58 corresponding with the inclination of the transition surface 34.

The third embodiment as shown in FIG. 8 differs from the second embodiment as shown in FIG. 7 in that the transition surface 34′ extends substantially horizontal.

The fourth embodiment as shown in FIG. 9 differs from the second embodiment as shown in FIG. 7 in that the abutment element 65 is rotatable instead of translatable.

The abutment element 65 is pivotable about a pivot axis 66 mounted on the headrest 8. The abutment element 65 is pivotable about a pivot axis 66 under spring force of a spring (not shown) in a direction as indicated by arrow R1, so that an end 67 of the abutment element 65 will always be in abutment with the step shaped element 31.

It is also possible that the abutment element 38 is located on the backrest portion 7 whilst the step shaped element 31 is located on the headrest 8. By such an embodiment the first higher step 32 needs to be located further away from the seat portion 6 than the second lower step.

It is also possible that the belt guide 19 is mounted on the backrest portion 7.

Preferably the belt guide 19, the operating element 41 for opening and closing the opening 25 of the belt guide 19, and the abutment element 35 are all located on the headrest 8 or the backrest portion 7 so that the distance between the operating element 41 and the abutment element 35 is constant and the length of the cable 45 can be constant as well. If the belt guide 19 and the operating element 41 are located on the headrest 8 and the abutment element 35 is located on the backrest portion 7 or the other way around, additional measurements may be taken for adjusting the length of the cable 45 so that in the first respectively second position of the abutment element 35, the operating element 41 will be in the first respectively second operating position.

It is also possible that the child vehicle seat is provided with one step shaped element, one abutment element and two operating elements cooperating with the one abutment element. In such a case the abutment element might be connected to the two operating elements by means of two cables, each cable connected with one end to the abutment element and connected with another end to one of the operating elements.

It is also possible that the abutment element is connected by means of several connectors to several operating elements, whereby not only the belt guide will be opened or closed but also other functions can be performed like warning signals, operating/blocking harness parts, blocking/allowing recline positions, indicators that move from a first position to a second position, indicating a yes/no, red/green, safe/unsafe situation.

Next to a belt guide for the shoulder portion of the vehicle belt, child vehicle seats also have belt guides for the lap portion of the vehicle belt. These belt guides could also have positions (open/close, red/green, . . . ) that can be linked to a first headrest position and a second headrest position. The operating elements can also be used for adjusting the width of the headrest side wings from one narrower position to a second wider position.

It is also possible that the abutment element does not abut against the second lower step but is only blocked from moving too far away from the parts 36, 37. In such a case the transition surface 34 may be large enough to be able to receive the abutment element 34 when the headrest 8 is moved downwards to the first headrest position 8. In such an embodiment the second lower step is a virtual step.

It is also possible that the connector is not a flexible cable but a rigid element.

It is also possible that the operating element 41 that closes the belt guide, is a rotating element instead of a translation pin. In FIG. 9, a pivotable abutment element 65 is shown, a similar rotating element could be used to open/close the belt guide.

Some child vehicle seats are adapted to fit different types of restraint, such as children of different sizes. A first type of restraint is a harness with shoulder straps integral with the child vehicle seat for the smallest children (group 0/1 from 40 cm-105 cm). In this case, the belt of the vehicle can be used to maintain the child vehicle seat on the seat of the vehicle, unless the latter is maintained by dedicated means, such as Isofix® clamps.

The second type of restraint, approximately starting at the age of 3 years, with a child having a length of more than 100 cm and approximately having a weight of the child greater than or equal to 15 kg, is the three-point seat belt of the vehicle to maintain the child (group 2/3, longer than 100 cm) in the child vehicle seat.

It is sometimes difficult to not be mistaken, or at least to not hesitate, in the fastening of the child vehicle seat to the vehicle, as there are multiple belt passage points of the vehicle to be used or not to be used according to the use in group 0/1 or in group 2/3 of the child restraint.

In particular, the vehicle belt may not be used to maintain the child in group 0/1, whether to replace the harness or as a complement to the latter. Inversely, in group 2/3, the child may be maintained by the vehicle belt, not by the harness in the child vehicle seat.

To attempt to limit this risk, regulatory indicators have been provided, placed at the suitable locations for each of the two groups. However, this is a system for aid, or for assistance, which is solely informative, which does not make it possible to block misuse.

There are other features of a child vehicle seat which might or might not be used under specific conditions like, whereby the user can easily make a mistake which feature may or may not be used according to the age and size of the child. Such features are for example the use of a support leg for group 0/1 but not for group 2/3, different head rest positions, the possibility to recline the seat or not.

At least one of the objects of the present disclosure is to provide means which can easily be operated and can be used to block a user from making a mistake in the method for restraining the child according to his age and his morphology or the method to use other features of the child vehicle seat.

This object is accomplished with the child vehicle seat according to the present disclosure in that the child vehicle seat comprises:
at least one step shaped element provided with at least a first higher step, a second lower step as well as a transition surface located between the first higher step and the second lower step,
at least one abutment element cooperating with the step shaped element, wherein the abutment element and the step shaped element are movable with respect to each other between at least a first position wherein the abutment element is under spring force in abutment with the first higher step, a transition position wherein the abutment element is under spring force in abutment with the transition surface and a second position wherein the abutment element is located opposite the second lower step,
at least one operating element connected to the abutment element by means of a connector, wherein the operating element is being moved from a first operating position when the abutment element is the first position to a second operating position by means of the abutment element when the abutment element is being moved to the second position and vice versa.

By moving the abutment element and the step shaped element with respect to each other, the operating element is being moved as well. The movement of the abutment element and the step shaped element is preferably related to a feature like adjusting the headrest, reclining the child vehicle seat, adjusting shoulder parts, arm rests, whereby at the same time the operating element is moved to a position to provide or block access to another feature like a belt guide, an indicator element moving from red to green, side parts of a headrest moving from narrow to wide, a shoulder rest moving from narrow to wide, a belt guide moving from invisible to visible, a recline function moving from possible to impossible (blocked). The different steps of the step shaped element define different positions of the abutment element and thus the operating element.

An embodiment of the child vehicle seat according to the present disclosure is characterized in that the connector comprises a cable connected with a first end to the abutment element and with a second end to the operating element.

Due to the cable the abutment element and the operating element are easily connected to each other, whereby the abutment element and the operating element can each be positioned at any desired location on the child vehicle seat. Another advantage is that the cable the abutment element and the operating element can be moved in different directions extending at an angle with respect to each other.

Another embodiment of the child vehicle seat according to the present disclosure is characterized in that the abutment element is under spring force of a first spring in abutment with the first higher step and the transition surface, whilst the operating element is movable against spring force of a second spring to the second operating position when the abutment element is the second position, whereby the spring force of the first spring is larger than the spring force of the second spring.

When using a cable or other kind of flexible connector, the first spring will always be able to push the abutment element under spring force in abutment with the first higher step and the transition surface of the step shaped element, independent of the operating position of the operating element.

Another embodiment of the child vehicle seat according to the present disclosure is characterized in that the child vehicle seat is provided with at least one belt guide for a vehicle belt, which belt guide is provided with an opening for inserting a vehicle belt inside the belt guide, wherein in the first operating position the opening of the belt guide is closed by means of the operating element, whilst in the second operating position the operating element is removed from the opening so that the opening of the belt guide is opened.

The opening of the belt guide will be closed by the operating element when using the child vehicle seat for the smallest children (group 0/1) and will be opened when using the child vehicle seat for larger children (group 2/3). When the belt guide is open, the vehicle belt can be guided through the belt guide and be used to maintain the child in the child vehicle seat.

Another embodiment of the child vehicle seat according to the present disclosure is characterized in that the child vehicle seat is provided with a headrest being movable with respect to the backrest portion from a first headrest position to a second headrest position, whereby the headrest is located closer to the seat portion in the first headrest position than in the second headrest position, whereby the backrest portion or the headrest comprises the at least one belt guide, the operating element is positioned on the backrest portion comprising the at least one belt guide or the headrest comprising the at least one belt guide, the abutment element is provided on the backrest portion and the step shaped element is provided on the headrest or the other way around, whereby when the headrest is in first headrest position, the abutment element is in the first position, the operating element is in the first operating position and the opening of the belt guide is closed, whilst when the headrest is in second headrest position, the abutment element is in the second position, the operating element is in the second operating position and the opening of the belt guide is opened.

The first headrest position will be used for the smallest children (group 0/1). In the first headrest position, the opening of the belt guide is closed, thereby blocking a user from inserting the vehicle belt into the belt guide. When moving the headrest from the first headrest position to the second headrest position, the opening of the belt guide will be opened, thereby providing access to the belt guide, so that the vehicle belt can be inserted and be used to maintain in a group 2/3 seat the child in the child vehicle seat.

The belt guide can be connected to the backrest portion or the movable headrest.

The operating element is located on the same part as the belt guide. So, if the belt guide is located on the headrest, the operating element is also located on the headrest. If the belt guide is located on the backrest portion, the operating element is also located on the backrest portion.

The abutment element is provided on the backrest portion and the step shaped element is provided on the headrest or the abutment element is provided on the headrest and the step shaped element is provided on the backrest portion.

In some embodiments, the belt guide can also be locked. However, to lock the belt guide the user may perform additional actions to the movement of the headrest. By the child vehicle seat according to the present disclosure the belt guide is automatically opened or closed by movement of the headrest.

Another embodiment of the child vehicle seat according to the present disclosure is characterized in that the at least one belt guide, the abutment element and the operating element are positioned on the headrest, whilst the step shaped element is provided on the backrest portion.

In this manner the belt guide is always in the correct position with respect to the headrest. The operating element may be located close to the belt guide and will be located on the headrest as well.

Having the abutment element as well as the operating element located on the headrest ensures that the distance between the abutment element and the operating element connected to the abutment element by means of the connector will always be the same, independent of the position of the headrest with respect to the backrest portion. Such a connector can be relatively simple, for example a cable or a stiff element.

Another embodiment of the child vehicle seat according to the present disclosure is characterized in that the child vehicle seat comprises two belt guides, one belt guide on each lateral side of the child vehicle seat.

Since a child vehicle seat can be positioned on the vehicle seat near the left or the right door, whereby the location of the vehicle belt differs, the child vehicle seat is preferably provided on both lateral sides with a belt guide.

Another embodiment of the child vehicle seat according to the present disclosure is characterized in that the child vehicle seat is provided with two step shaped elements, two abutment elements and two operating elements, wherein each set of one step shaped element, one abutment element and one operating element cooperates with another one of the belt guides.

In this manner the opening of each belt guide is being opened or closed by means of an independent set of a step shaped element, an abutment element and an operating element. If one set fails a user can still see that the other belt guide is closed, using this as a warning that something is wrong.

Another embodiment of the child vehicle seat according to the present disclosure is characterized in that the child vehicle seat is provided with one step shaped element, one abutment element and two operating elements cooperating with the one abutment element.

By having only one step shaped element and only one abutment element cooperating with two operating elements, for example to open and close two openings of two belt guides, both openings are always simultaneously opened or closed. Furthermore, there is a reduction in the number of components being used, thereby reducing the costs. The operating elements can, for example, be located on a left side and a right side of the child vehicle seat.

Another embodiment of the child vehicle seat according to the present disclosure is characterized in that the abutment element comprises a pen being movable under spring force towards the step shaped element.

Such a pen being linear movable by means of a spring provides a simple abutment element, whereby due to the spring force the pen will always be forced in the direction of the step shaped element.

Another embodiment of the child vehicle seat according to the present disclosure is characterized in that the abutment element is rotatable under spring force towards the step shaped element.

Such an abutment element being rotatable movable by means of a spring provides a simple abutment element, whereby due to the spring force the abutment element will always be forced in the direction of the step shaped element.

Another embodiment of the child vehicle seat according to the present disclosure is characterized in that the abutment element is connected by means of several connectors to several operating elements.

By having the abutment element being connected by means of several connectors to several operating elements, several functions belonging to the several operating elements can be performed at the same time, whilst only one the abutment element cooperating with a step shaped element is needed.

1. A child restraint comprising:
a seat bottom,
a backrest coupled to the seat bottom, and
a headrest mounted to the backrest for upward and downward movement relative to the backrest between a lowered position spaced a first distance from the seat bottom and a raised position spaced a second distance greater than the first distance,
wherein the headrest includes a headrest shell, configured to support a head of a child, a belt guide coupled to the headrest shell and formed to include a belt path configured to receive a vehicle seat belt when the headrest is in the raised position to establish a booster seat mode of the child restraint, and a belt-installation controller/controller coupled to the belt guide and moveable relative to the belt guide between an interference configuration when the headrest is in the lowered position in which the belt-installation controller blocks installation of the vehicle seat belt with the belt guide, and an installation configuration when the headrest is in the raised position in which the belt guide is free to receive the vehicle seat belt to establish the booster seat mode.

2. The child restraint of claim 1, wherein the belt-installation controller includes a belt path shield coupled to the belt guide and configured to cover an inlet to the belt path in the interference configuration to block entry of the vehicle seat belt and a shield actuator coupled to the belt path shield and configured to move the belt path shield relative to the belt guide in response to the upward and downward movement of the headrest relative to the backrest.

3. The child restraint of claim 2, wherein the shield actuator includes an abutment member coupled to the headrest shell and configured to engage a portion of the backrest in the lowered position, a connector coupled to the abutment member and to the belt path shield, a first biasing member coupled to the abutment member and configured to urge the abutment member toward the backrest, and a second biasing member coupled to the belt path shield and configured to urge the belt path shield to cover the inlet to the belt path.

4. The child restraint of claim 3, wherein the backrest includes a first step spaced a first distance from the headrest, a second step spaced a second distance from the headrest greater than the first distance, and a transition surface between the first step and the second step, and
wherein the abutment member engages the first step when the headrest is in the lowered position and interfaces with the second step when the headrest is in the raised position to cause the first biasing member to pull the connector and the belt path shield to the installation configuration so that the belt path is open to receive the vehicle seat belt.

5. The child restraint of claim 3, wherein the connector includes a cable.

6. The child restraint of claim 1, wherein the backrest includes a first step spaced a first distance from the headrest and configured to engage the belt-installation controller when the headrest is in the lowered position and a second step spaced a second distance from the headrest different than the first distance and configured to interface with the belt-installation controller when the headrest is in the raised position to allow movement of the belt-installation controller between the interference configuration and the belt-installation configuration.

7. The child restraint of claim 1, wherein the belt-installation controller includes a belt path shield coupled to the belt guide and configured to cover an inlet to the belt path in the interference configuration to block entry of the vehicle seat belt, a first biasing member configured to urge the belt path shield to the interference configuration when the headrest is in the lowered position, and a second biasing member configured to urge the belt path shield to the belt-installation configuration when the headrest is in the raised position.

8. A child restraint comprising:
a shell configured to support at least a portion of a child for transportation in a vehicle in a first seating mode for children of a first size and a second seating mode for children of a second size,
a belt guide coupled to the shell and configured to receive an attachment belt, and
a belt-installation controller moveable relative to the belt guide between an interference position in the first seating mode in which the belt-installation controller blocks installation of the attachment belt with the belt guide, and an installation position in the second seating mode in which the belt guide is free to receive the attachment belt.

9. The child restraint of claim 8, wherein the belt-installation controller includes a belt path shield coupled to the belt guide and configured to cover an inlet to the belt path in the interference position to block entry of the attachment belt and a shield actuator coupled to the belt path shield and configured to move the belt path shield relative to the belt guide in response to the seat shell changing from the first seating mode to the second seating mode.

10. The child restraint of claim 9, wherein the shield actuator includes an abutment member configured to engage a portion of the seat shell, a connector coupled to the abutment member and to the belt path shield, a first biasing member coupled to the abutment member and configured to urge the abutment member toward the portion of the seat shell, and a second biasing member coupled to the belt path shield and configured to urge the belt path shield to cover the inlet to the belt path to establish the interference position.

11. The child restraint of claim 10, wherein the portion of the seat shell includes a first step, a second step, and a transition surface between the first step and the second step, and
wherein the abutment member engages the first step when the seat shell is in the first seating mode and interfaces with the second step when the seat shell is in the second seating mode to cause the first biasing member to pull the connector and the belt path shield to the installation position so that the belt path is open to receive the vehicle seat belt.

12. The child restraint of claim 10, wherein the connector includes a cable.

13. The child restraint of claim 8, wherein the backrest includes a first step spaced a first distance from the headrest and configured to engage the belt-installation controller when the headrest is in the lowered position and a second step spaced a second distance from the headrest different than the first distance and configured to engage the belt-installation controller when the headrest is in the raised position to allow movement of the belt-installation controller between the interference configuration and the belt-installation configuration.

14. The child restraint of claim 9, wherein the belt-installation controller includes a belt path shield coupled to the belt guide and configured to cover an inlet to the belt path in the interference position to block entry of the attachment belt, a first biasing member configured to urge the belt path shield to the interference position when the seat shell is in the first seating mode, and a second biasing member configured to urge the belt path shield to the belt-installation position when the seat shell is in the second seating mode.

15. A child vehicle seat comprising a seat portion and a backrest portion, the child vehicle seat comprising:
at least one step shaped element provided with at least a first step, a second step, and a transition surface located between the first step and the second step,
at least one abutment element cooperating with the step shaped element, wherein at least one of the abutment element and the step shaped element is movable with respect to each other between at least a first position wherein the abutment element abuts the first step and a second position wherein the abutment element interfaces with the second step,
at least one operating element coupled to the abutment element, wherein the operating element is configured to move from a first operating position when the abutment element is in the first position to a second operating position by way of the abutment element when the abutment element is moved to the second position and vice versa.

16. The child vehicle seat of claim 15, wherein the connector comprises a cable connected with a first end to the abutment element and with a second end to the operating element.

17. The child vehicle seat of claim 15, wherein the abutment element is under spring force of a first spring and in abutment with the first higher step and the transition surface, whilst the operating element is movable against spring force of a second spring to the second operating position when the abutment element is the second position, whereby the spring force of the first spring is larger than the spring force of the second spring.

18. The child vehicle seat of claim 15, wherein the child vehicle seat is provided with at least one belt guide for a vehicle belt, which belt guide is provided with an opening for inserting a vehicle belt inside the belt guide, wherein in the first operating position the opening of the belt guide is closed by means of the operating element, whilst in the second operating position the operating element is removed from the opening so that the opening of the belt guide is opened.

19. The child vehicle seat of claim 18, wherein the child vehicle seat is provided with a headrest being movable with respect to the backrest portion from a first headrest position to a second headrest position, whereby the headrest is located closer to the seat portion in the first headrest position than in the second headrest position, whereby the backrest portion or the headrest comprises the at least one belt guide, the operating element is positioned on the backrest portion comprising the at least one belt guide or the headrest comprising the at least one belt guide, the abutment element is provided on the backrest portion and the step shaped element is provided on the headrest or the other way around, whereby when the headrest is in first headrest position, the abutment element is in the first position, the operating element is in the first operating position and the opening of the belt guide is closed, whilst when the headrest is in second headrest position, the abutment element is in the second position, the operating element is in the second operating position and the opening of the belt guide is opened.

20. The child vehicle seat of claim 19, wherein the at least one belt guide, the abutment element and the operating element are positioned on the headrest, whilst the step shaped element is provided on the backrest portion.
